(19) United States
(12) Patent Application Publication
(10) Pub. No.: US 2014/0244762 A1
(43) Pub. Date: Aug. 28, 2014

(54) APPLICATION DISTRIBUTION PLATFORM FOR RATING AND RECOMMENDING APPLICATIONS

(71) Applicants: Matthew Wyndowe, New York, NY (US); Bruce Rogers, Los Gatos, CA (US); Tirunelveli R. Vishwanath, Santa Clara, CA (US); Aaron Brady, San Jose, CA (US)

(72) Inventors: Matthew Wyndowe, New York, NY (US); Bruce Rogers, Los Gatos, CA (US); Tirunelveli R. Vishwanath, Santa Clara, CA (US); Aaron Brady, San Jose, CA (US)

(73) Assignee: Facebook, Inc., Menlo Park, CA (US)

(21) Appl. No.: 13/777,982

(22) Filed: Feb. 26, 2013

(51) Int. Cl. H04L 29/08

(52) U.S. Cl. CPC H04L 67/10
USPC 709/205

(57) ABSTRACT

Techniques for assessing application quality and recommending applications to users are disclosed herein. A method according to the techniques monitors the users' activities of using the applications and records the usage information. The method further generates and randomly presents rating requests to users who are using the applications to solicit ratings of the applications. An application quality score for an application is calculated and updated based on the usage information and ratings for a group of users having common demographic or geographic attributes. The method automatically recommends an application to a user depending on the corresponding application quality score and a taste similarity score for the user calculated by a taste similarity algorithm based on the user's specific social network information.

### FIELD OF THE INVENTION

This invention relates generally to an application distribution platform, and in particular to an application distribution platform using social networking data to rate and recommend applications.

### BACKGROUND

As electronic devices including laptops, tablets, mobile telephones, personal digital assistants, smart phones continue to grow more advanced in their networking functionalities, digital distribution to the devices becomes increasingly popular. Digital distribution is a form of delivering media content such as audio, video, software and video games, without the use of physical media but over online delivery mediums, such as the Internet. Digital distribution bypasses conventional physical distribution methods, including paper, magnetic discs, optical discs and semiconductor drives. Digital distribution becomes prominent nowadays with the advancement of network bandwidth capabilities.

Various application distribution platforms emerge as the platforms and the market places for shopping applications for electronic devices. A typical application distribution platform allows users to browse and download applications from the platform. The applications can be available either free or at a cost. As the number of applications in the application distribution platform grows, it is hard for users to find a right application by just browsing the platform. In order to facilitate the process of finding applications, the application distribution platform usually provides a search mechanism as well as a ranking mechanism. The ranking mechanism solicits feedback from users to assign rating scores to the applications and sorts the application in one or more categories based on the rating scores.

However, the existing ranking mechanism has drawbacks. The user feedback is generated by the user clicking on numerical scales. The ranking mechanism does not differentiate users with little or no experiences from using the application from users with extensive experiences from using the application. This creates a loophole for cheating by using bots or other techniques to generate the false user feedback. Further, the feedback solicitation process is passive. Most users do not even bother and do not have the incentive to leave feedback for applications. The application distribution platform simply makes the same recommendation of applications to users based on the overall rankings of the applications.

### SUMMARY

The technology introduced here provides the benefits of accurate assessing qualities of applications based on the actual usage data and randomized surveys. The technology further provides personalized recommendation based on the social networking data. In particular, the technology introduced here includes a method for assessing application quality and recommending applications to users. The method monitors the users' activities of using the applications and records the usage information. The method further generates and randomly presents rating requests to users who are using the applications to solicit ratings of the applications. An application quality score for an application is calculated and updated based on the usage information and ratings for a group of users having common demographic or geographic attributes. The method automatically recommends an application to a user depending on the corresponding application quality score and a taste similarity score for the user calculated by a taste similarity algorithm based on the user's specific social network information.

In accordance with the techniques introduced here, therefore, a method for assessing and recommending applications is provided. The method provides a computer software application to a plurality of users, and further receives user activity data of at least some of the plurality of users including a first user. Each user is active within an instance of the application running on a computer system. The method further randomly selects the first user, and sends a survey regarding the application to the first user. After collecting a survey answer from the first user, the method records the survey answer and the user activity data in a database stored in a server. Then the method generates an application quality score for the application depending on the survey answer and the user activity data, wherein the application quality score suggests a quality level of the application.

In accordance with the techniques introduced here, therefore, a system for assessing and recommending applications is also provided. The system includes a survey module, a database, an application assessing module and a recommendation module. The survey module is configured to transmit rating requests for an application to a plurality of users, wherein the plurality of users are randomly selected from users who are actively using the application. The database is configured to record usage data of the users who are actively using the application and rating answers from the plurality of users, wherein each of the rating answers is a scale rating number. The application assessing module is configured to calculate an application quality score for the application based on the rating answers and the usage data. The recommendation module is configured to generate and send a recommendation of the application to a user who has not used the application.

Other aspects of the technology introduced here will be apparent from the accompanying figures and from the detailed description, which follows.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates an example social networking system.

FIG. 2 illustrates an example social networking system front end that contains multiple communication channels.

FIG. 3 illustrates an example application distribution platform of a social networking system.

FIG. 4 illustrates an example application rating process for an application distribution platform.

FIG. 5 illustrates an example application recommending process of an application distribution platform.

FIG. 6 illustrates an example network environment of an application distribution platform.

FIG. 7 is a high-level block diagram showing an example of the architecture of a computer node, which may represent any node or server described herein.

### DETAILED DESCRIPTION

References in this description to “an embodiment”, “one embodiment”, or the like, mean that the particular feature, function, or characteristic being described is included in at least one embodiment of the present invention. Occurrences of such phrases in this description do not necessarily all refer to the same embodiment, nor are they necessarily mutually exclusive.

At least one embodiment of the present invention discloses a social networking system including an application distribution platform using social networking information to assess and recommend applications to users of the social networking system. The social networking system monitors and records usage data of the users using applications. The system randomly selects the users who are currently using the applications and sends rating survey requests to them. The survey answers are returned to the system. Based on the survey answers and the usage data, the system can generate and update an application quality score for each application. The application distribution platform can present a chart listing the applications by the order of the application quality scores. The platform can also send recommendations to the users for applications with good application quality scores. For instance, the platform can send a recommendation of an application to a user who has used a similar application. Or the platform can send a recommendation of an application to a user because another user who shares common interests with the user has used the application.

The social networking system, such as a social networking website, enables its users to interact with the social networking system, with the applications provided by the system, and with each other through, the system. Typically, to become a registered user of a social networking system, an entity, either human or non-human, registers for an account with the social networking system. Thereafter, the registered user may log into the social networking system via an account by providing, for example, a correct login ID or username and password. As used herein, a “user” may be an individual (human user), an entity (e.g., an enterprise, business, or third party application), or a group (e.g., of individuals or entities) that interacts or communicates with or over such a social networking system.

When a user registers for an account with a social networking system, the social networking system may create and store a record, often referred to as a “user profile”, associated with the user. The user profile may include information provided by the user and information gathered by various systems, including the social networking system, relating to activities or actions of the user. For example, the user may provide his name, profile picture, contact information, birth date, gender, marital status, family status, employment, education background, preferences, interests, and other demographical information to be included in his user profile. The user may identify other users of the social networking system that the user considers to be his friends. A list of the user's friends or first degree contacts may be included in the user's profile. Connections in social networking systems may be in both directions or may be in just one direction. Connections may be added explicitly by a user, for example, the user selecting a particular other user to be a friend, or automatically created by the social networking system based on common characteristics of the users (e.g., users who are alumni of the same educational institution).

A user's activities on the social networking system, such as frequency and time period of using a particular application provided by the system, may also provide information that may be included in the user's profile. Again, such information may be updated from time to time or in real time to reflect the user's interests on applications.

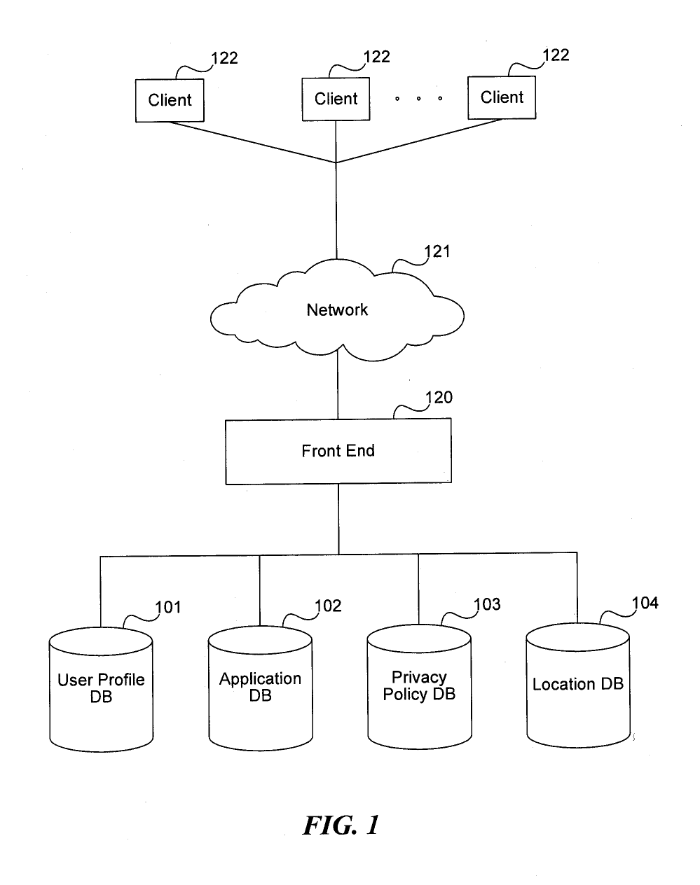

FIG. 1 illustrates an example social networking system. The social networking system may store user profile data and social graph information in user profile database 101. The social networking system may store user application usage data in application database 102. For example, a user may have been using an application provided by the social networking system and cause the usage data to be stored in the application database 102. The social networking system may store user privacy policy data in privacy policy database 103. The social networking system may further store geographic and location data in location database 104. The databases 101, 102, 103 and 104 may be connected to the social networking system's front end 120. In one embodiment, the front end 120 may interact with client device 122 through network 121. The client device 122 is generally a computer or computing device including functionality for communicating (e.g., remotely) over a computer network. Client device 122 may be a desktop computer, laptop computer, tablet computer, personal digital assistant (PDA), navigation system, smart phone or other cellular or mobile phone, or mobile gaming device, among other suitable computing devices. The client device 122 may execute one or more client applications, such as a web browser (e.g., Microsoft Windows Internet Explorer, Mozilla Firefox, Apple Safari, Google Chrome, and Opera, etc.) or special-purpose client application (e.g., Facebook for iPhone, etc.), to access and view content over a computer network. Front end 120 may include web or HTTP server functionality, as well as other functionality, to allow users to access the social networking system. The network 121 generally represents a network or collection of networks (such as the Internet or a corporate intranet, or a combination of both) over which the client devices 122 may access the social networking system.

In one embodiment, the social networking system stores application usage data in the application database 102. The system may monitor users using the applications provided by the social networking system and records the time stamps related to the usage. For example, the application database may record the time stamps when a user starts and ends using a particular application. The application database may further record other events such as a user pausing a game application, a user switching to another application, and a user installing or uninstalling an application.

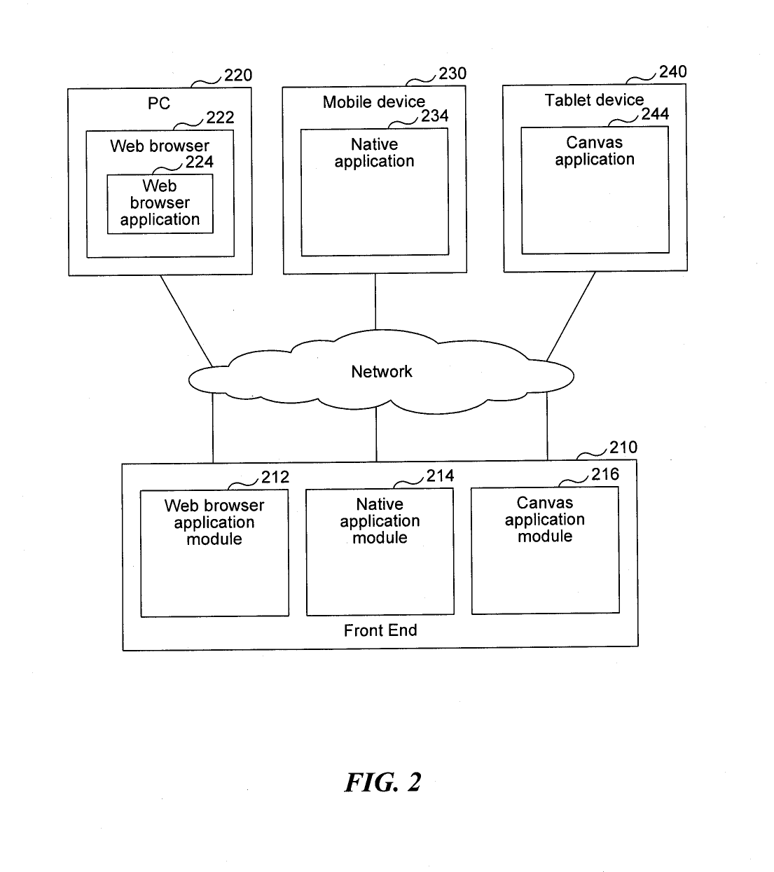

There are different ways for applications to communicate with the social networking system. FIG. 2 illustrates an example social networking system front end that contains multiple communication channels. A user of various client devices may choose to access the social networking system via various different mechanisms. For examples, PC 220 connects to the standard website of the social networking system through a standard web browser 222. The web browser 222 is running a web page application 224 which communicates with a web page application module 212 of the front end 210. Similarly, mobile device 230 may connect through a native social networking application 234 resident in its application memory. The native application 234 communicates with a native application module 214 of the front end 210. In some embodiments, a tablet device 240 may include a canvas application 244 running on a canvas of a web page. The canvas application 244 communicates with a canvas application module 216 of the front end 210. Social networking front end 120 communicates with the various client devices 220, 230 and 240 based upon their specific computing device. For instance, the front end 120 can supply data to the applications 224, 234 and 244. Further, the front end 120 can keep track of the user activities for users who are using the applications 224, 234 and 244.

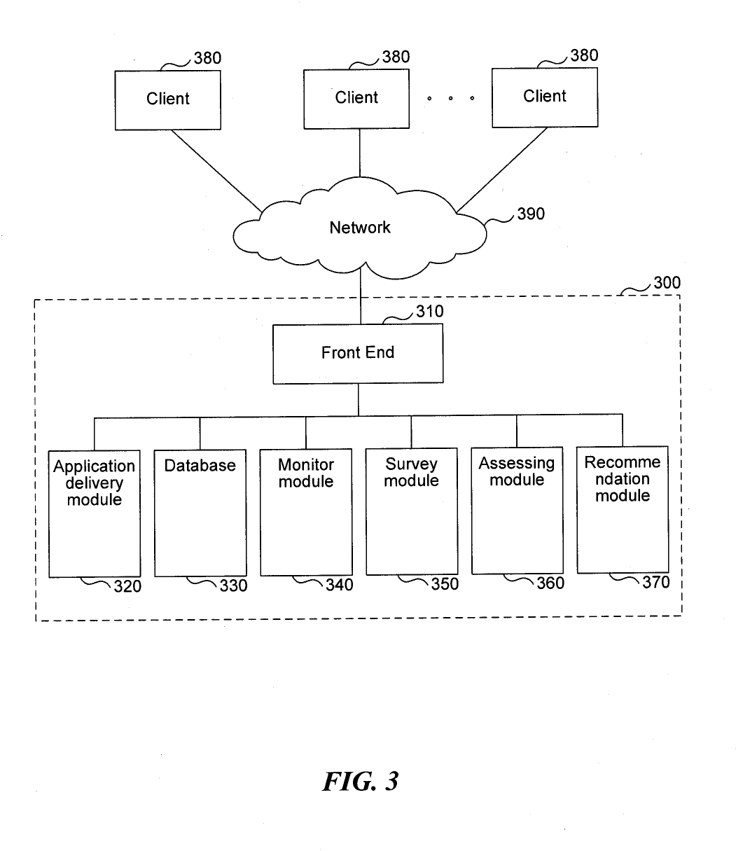

The social networking system may collect feedback for the applications from the users who are using or have been using the applications. FIG. 3 illustrates an example application distribution platform 300 of the social networking system which has functionalities of rating recommending applications. The application distribution platform 300 includes a front end 310. The front end 310 may interact with client devices 380 through networking 390. The client devices 380 may search or browse via an interface provided by the front end 310 to locate the desired application distributed by the application distribution platform 300. For instance, if a client device 380 is a laptop computer running a web browser connected to the front end 310, the front end 310 provides a HTTP web page that lists the applications and renders a search interface for searching applications using keywords. If a client device 380 is a smart phone running a native platform application, the client device 380 provides information to the native platform application to list the available applications and to search for an application. In one embodiment, the front end 310 of the application distribution platform 300 can be a part of the front end of the social networking system. In another embodiment, the front end 310 of the application distribution platform 300 is a module separate from the front end of the social networking system.

The application distribution platform 300 includes an application delivery module 320, as shown in the FIG. 3. The delivery module 320 is responsible for sending the application to the user devices 380 upon request. When a request for an application from a user device 380 is received by the delivery module 320, the delivery module 320 can directly send data of the application to the user device 380, or instruct another server or node of the social networking system to send the data of the application to the user device 380. Depending on the situation, the delivery module 320 can send the data of the application via the front end 310, or bypass the front end 310. For instance, a user device 380 running a web browser program requests a web page version of an application. Upon receiving the request, the delivery module 380 sends the data of the application to the front end 310. The front end 310 converts the data into instructions executable by the web browser and sends the instructions to the user device 380. Accordingly, the user device 380 executes the received instructions to run the web page version of the application within the web browser. In another example, a user device 380 sends a request for a native version of an application. Upon receiving the request, the delivery module 380 instructs another storage node of the social networking system to send the data of the application directly to the user device 380. Upon receiving the data of the application, the user device 380 installs the native version of the application and starts to run the application on top of the operating system of the user device 380.

The application distribution platform 300 further includes a database 330 configured to record usage data associated with the applications, and a monitor module 340. Whether a user is using a webpage version of an application, a canvas version of the application, or a native version of the application, the monitor module 340 of the application distribution platform 300 monitors the user activities related to the application and records the usage data into the database 330. Based on the database 330, the application distribution platform knows when and for how long a particular user has been using a particular application. These usage data stored in the database 330 will be used to assess the quality of the application, as disclosed in the following paragraphs.

The application distribution platform 300 includes a survey module 350. As the monitor module 340 continues to monitor the usage of the applications, the survey module 350 can identify the users who are currently using a particular application. The survey module 350 randomly selects a group of users among the users who are currently using the application. The survey module 350 generates a survey request for the application, and transmits the survey request to the selected group of the users. The user devices 380 of this group of users receive the survey request and render the survey on the screens of the user devices. The survey can be a scale rating questionnaire. For example, a user is playing a game application running on a user device 380. The monitor module 340 monitors the user activities of the user playing the game application. The user is selected by the survey module 350. The survey module 350 sends a survey request to the user's user device 380. The user device 380 pauses the game application and generates a window on top of the game application. The window displays a survey questionnaire and a list of choices for scale rating numbers from 1 to 5. The user selects a number, e.g. 4. The window closes and the user can continue to play the game application. The survey answer (e.g. scale rating of 4) is sent back to the application distribution platform 300. In one embodiment, the database 330 stores the survey answers. In another embodiment, a database separate from the database 330 is responsible for storing the survey answers.

The application distribution platform 300 further includes an application assessing module 360 configured to calculate an application quality score for each application distributed by the application distribution platform 300. In order to calculate the application quality score, the assessing module 360 retrieves the application usage data and the survey answers from the database 330. The assessing module 360 calculates an application quality score based on the application usage data and the survey answers.

In one embodiment, the assessing module 360 determines a number of days among the last N days on which a user used an application. N is a predetermined number, e.g. 60. For example, if the usage data shows that the user has used the application on 12 days among the last 60 days, the assessing module 360 determines an active usage value for that particular user and for that particular application as 12. Further, the assess module 360 retrieves the survey answer (e.g., a scale rating number 4) for the user and the application from the database 330.

In one embodiment, the assessing module 360 calculates a user quality score of the application for the user. In one example, the user quality score can be determined by a square of the survey answer (e.g., 4) plus a common logarithm of the active usage value (e.g., 12). The assessing module 360 performs the same calculation for all selected users who have returned the survey answers. Then, the assessing module 360 generates an application quality score for the application by averaging the user quality scores for these selected users. Therefore, for each distributed application, the application distribution platform 300 has an application quality score based on the updated usage data and recent survey results to reflect the users' feedbacks and enthusiasm to the application.

The application distribution platform 300 can further include a recommendation module 370 configured to generate and send a recommendation of the application to a user who has not used the application. For example, the recommendation module 370 determines that the application quality score of an application exceeds a threshold value. The recommendation module 370 further identifies a user who has not used the application and a number of applications which the user has used. The recommendation module 370 further calculates a taste similarity score which indicates the similarity between the application and the used applications. If the taste similarity score also exceeds a second threshold value, the recommendation module 370 sends a recommendation to the user. In some embodiments, that means the recommendation module 370 transmits a recommendation notice to a user device 380 of the user.

The recommendation module 370 can further generate an application chart which lists the application distributed by the platform 300 based on the application quality scores. The application chart can be sent to user devices 380 via the front end 310 as a part of the web content of the social networking system. For example, the recommendation module 370 may generate an application chart for the applications in the strategy game category for the US market. The chart lists the strategy game applications based on the application quality scores calculated from user information of US users. The recommendation module 370 can update the application chart periodically or in real time based on the new user usage data and new survey answers. The front end 310 renders the application chart as a web page or a portion of a web page for the social networking system that is to be displayed on user devices 380.

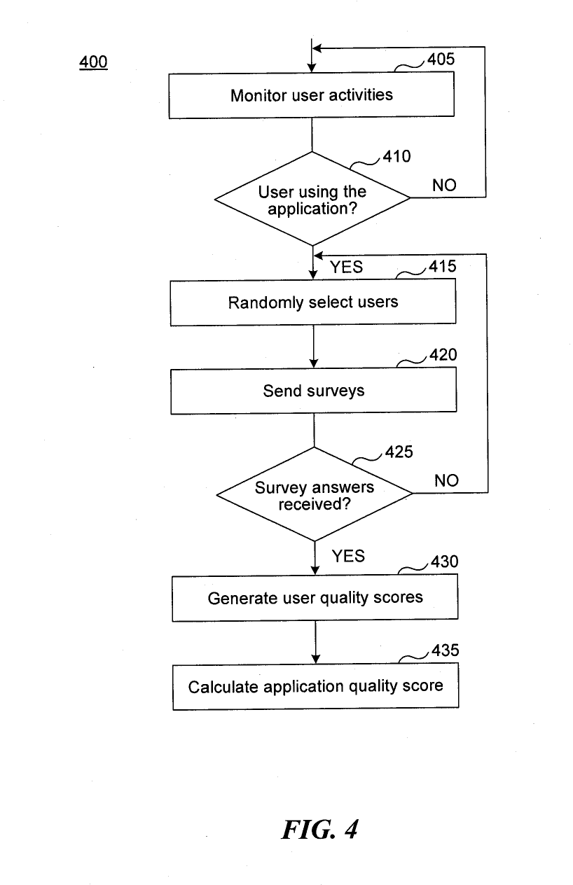

FIG. 4 illustrates an example application rating process 400 of an application distribution platform. At step 405, the application distribution platform monitors user activities of a plurality of users using an application. At step 407, the platform determines an active usage value of the application for each selected user. The active usage value is determined by a number of days among the last N days on which that user used the application, wherein N is a predetermined number. At step 410, the platform determines whether there is any user who is currently using the application. If there is no user using the application, the platform continues to monitor the user activities. If there is at least one user who is using the application, the platform continues to randomly select a group of users among all users who are using the application (415). Then at step 420, the platform sends surveys to the selected group of users. The platform continues to check whether any survey answer is received from the users at 425 within a predetermined time period. If there is no survey answer received within the time period, the platform may decide to select other users and sends more surveys to the selected users. If the platform receives the survey answers, the platform continues to step 430. In one embodiment, the survey answer is a rating scale number selected by the user. At step 430, the platform generates a user quality score of that application for each user. In one embodiment, the user quality score is determined by a square of the survey answer plus a common logarithm of an active usage value of that user. Then at step 435, the platform calculates an application quality score of the application by averaging the user quality scores of the application for the selected users.

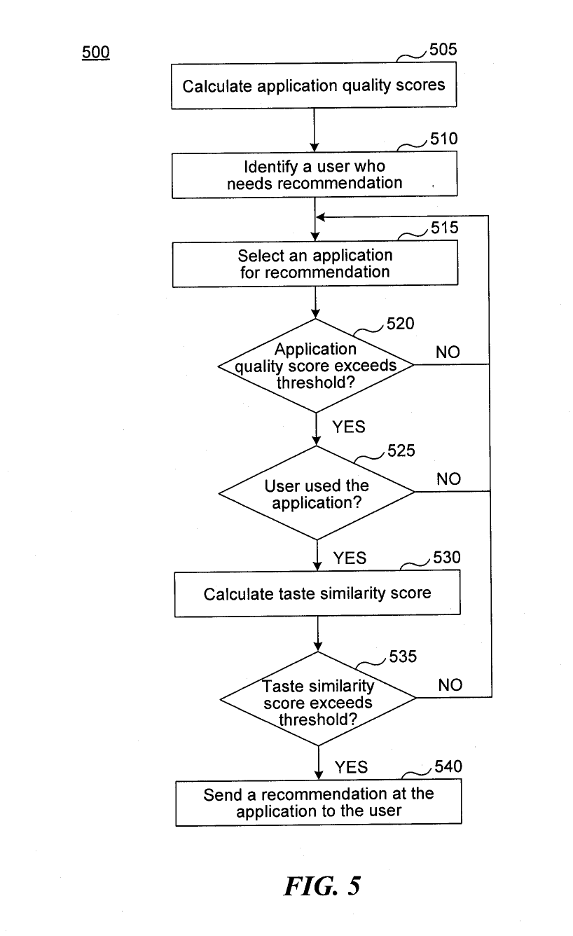

FIG. 5 illustrates an example application recommending process 500 of an application distribution platform. At step 505, the platform calculates an application quality score for each application, in a way similar to the process 400. At step 510, the platform identifies a user who needs or likely wants a recommendation of an application. At step 515, the platform selects an application for recommendation. The platform at step 520 checks whether the selected application has an application quality score exceeding a predetermined threshold value. If the application quality score does not exceed the threshold value, the platform goes back to select another application. If the application quality score does exceed the threshold value, the platform continues to step 525. At step 525, the platform checks whether the user has used the application yet. In some embodiments, the platform checks that by scanning the user account of the user to see whether the account has registered the installation of the application on any of the user devices associated with that user account. If the user has already used the application, the platform goes back to select another application recommendation. Otherwise, the platform calculates a taste similarity score between the application and the user at step 530. There are various possible ways to calculate the taste similarity score. For instance, in one embodiment, the taste similarity score is calculated based on the overlapping between the applications which that user has used and applications which share users with the recommending application. In another embodiment, the taste similarity score is calculated based on the similarity between the recommending application and the applications which that user has used. In yet another embodiment, the taste similarity score is calculated based on closeness in social networking graphs between that user and the users who have good user quality scores for the recommending application. Then at step 535, the platform determines whether the taste similarity score exceeds a second predetermined threshold value. If the taste similarity score does not exceed the second predetermined threshold value, the platform goes back to select another application for recommendation. Otherwise, at step 540, the platform continues to send a recommendation of the application to the identified user.

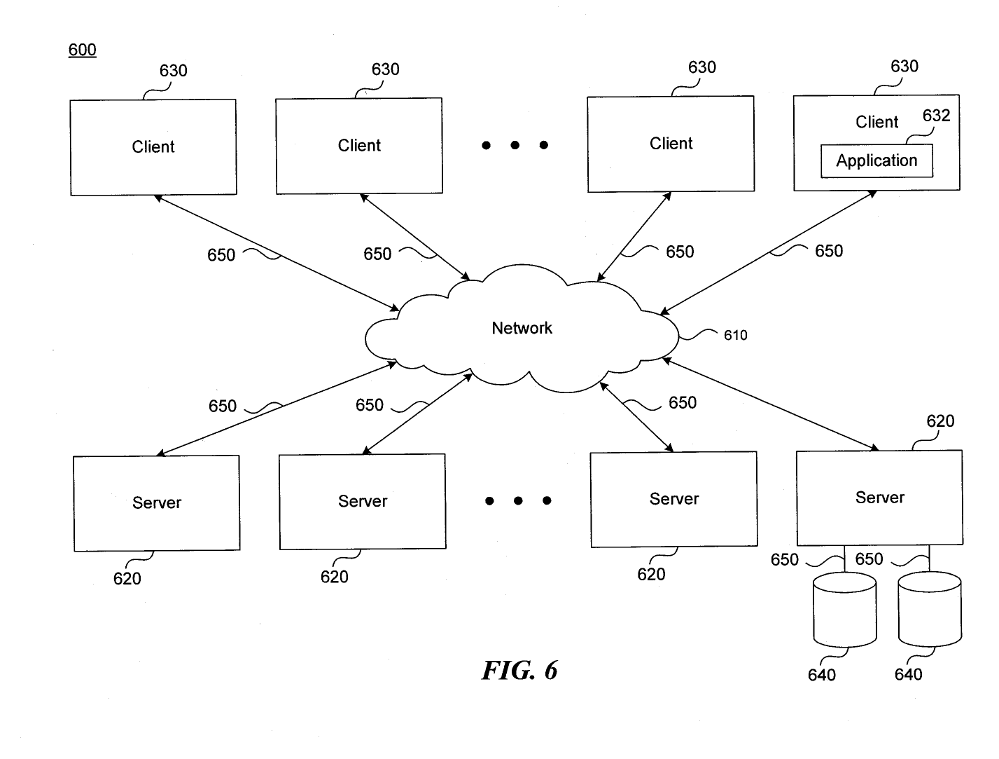

While the foregoing embodiments may be implemented in a variety of network configurations, the following illustrates an example network environment for the social networking system. FIG. 6 illustrates an example network environment 600. Network environment 600 includes a network 610 coupling one or more servers 620 and one or more clients 630 to each other. Network environment 600 also includes one or more data storage 640 linked to one or more servers 620. Particular embodiments may be implemented in network environment 600. For example, social networking system front end may be written in software programs hosted by one or more servers 620. For example, application databases may be stored in one or more storage 640. In particular embodiments, network 610 is an intranet, an extranet, a virtual private network (VPN), a local area network (LAN), a wireless LAN (WLAN), a wide area network (WAN), a metropolitan area network (MAN), a portion of the Internet, or another network 510 or a combination of two or more such networks 610. The present disclosure contemplates any suitable network 610.

One or more links 650 couple a server 620 or a client 630 to network 610. In one embodiment, one or more links 650 each includes one or more wired, wireless, or optical links 650. In another embodiment, one or more links 650 each includes an intranet, an extranet, a VPN, a LAN, a WLAN, a WAN, a MAN, a portion of the Internet, or another link 650 or a combination of two or more such links 650. The present disclosure contemplates any suitable links 650 coupling servers 620 and clients 630 to network 610.

In one embodiment, each server 620 may be a unitary server or may be a distributed server spanning multiple computers or multiple datacenters. Servers 620 may be of various types, such as, for example and without limitation, web server, news server, mail server, message server, advertising server, file server, application server, exchange server, database server, or proxy server. In some embodiments, each server 620 may include hardware, software, or embedded logic components or a combination of two or more such components for carrying out the appropriate functionalities implemented or supported by server 620.

In one embodiment, one or more data storages 640 may be communicatively linked to one or more servers 620 via one or more links 650. In some embodiments, data storages 640 may be used to store various types of information. In some embodiments, data storage 640 may have interfaces that enable servers 620 or clients 630 to manage, e.g., retrieve, modify, add, or delete, the information stored in data storage 640.

In one embodiment, each client 630 may be an electronic device including hardware, software, or embedded logic components or a combination of two or more such components and capable of carrying out the appropriate functions implemented or supported by client 630. For example and without limitation, a client 630 may be a desktop computer system, a notebook computer system, a netbook computer system, a handheld electronic device, or a mobile telephone. The present disclosure contemplates any suitable clients 630. A client 630 may enable a network user at client 630 to access network 630. A client 630 may enable its user to communicate with other users at other clients 630.

A client 630 may run one or more application 632. The application 632 can be a web browser 632, such as Microsoft Internet Explorer, Google Chrome, Mozilla Firefox, or Apple Saffari, and may have one or more add-ons, plug-ins, or other extensions. A user at client 630 may enter a Uniform Resource Locator (URL) or other address directing the web browser 632 to a server 620, and the web browser 632 may generate a Hyper Text Transfer Protocol (HTTP) request and communicate the HTTP request to server 620. Server 620 may accept the HTTP request and communicate to client 630 one or more Hyper Text Markup Language (HTML) files responsive to the HTTP request. Client 630 may render a web page based on the HTML files from server 620 for presentation to the user. The present disclosure contemplates any suitable web page files. Herein, reference to a web page encompasses one or more corresponding web page files (which a browser may use to render the web page) and vice versa, where appropriate.

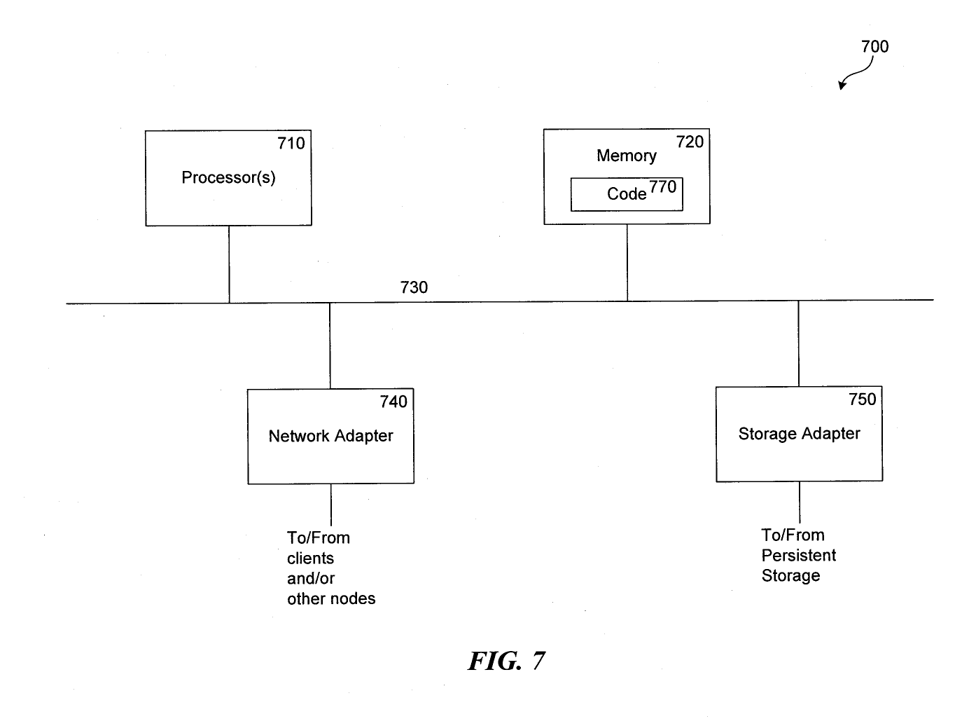

FIG. 7 is a high-level block diagram showing an example of the architecture of a computer node, which may represent any node or server described herein. The node 700 includes one or more processors 710 and memory 720 coupled to an interconnect 730. The interconnect 730 shown in FIG. 7 is an abstraction that represents any one or more separate physical buses, point to point connections, or both connected by appropriate bridges, adapters, or controllers. The interconnect 730, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 710 is/are the central processing unit (CPU) of the storage controller 700 and, thus, control the overall operation of the node 700. In certain embodiments, the processor(s) 710 accomplish this by executing software or firmware stored in memory 720. The processor(s) 710 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 720 is or includes the main memory of the node 700. The memory 720 represents any form of random access memory (RAM), read-only memory (ROM), flash memory, or the like, or a combination of such devices. In use, the memory 720 may contain a code 770 containing instructions according to the techniques disclosed herein.

Also connected to the processor(s) 710 through the interconnect 730 are a network adapter 740 and a storage adapter 750. The network adapter 740 provides the node 700 with the ability to communicate with remote devices, over a network and may be, for example, an Ethernet adapter or Fibre Channel adapter. The network adapter 740 may also provide the node 700 with the ability to communicate with other nodes within the cluster. In some embodiments, a node may use more than one network adapter to deal with the communications within and outside of the cluster separately. The storage adapter 750 allows the node 700 to access a persistent storage, and may be, for example, a Fibre Channel adapter or SCSI adapter.

The code 770 stored in memory 720 may be implemented as software and/or firmware to enable the processor(s) 710 to carry out actions described above. In certain embodiments, such software or firmware may be initially provided to the node 700 by downloading it from a remote system through the node 700 (e.g., via network adapter 740).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic”, as used herein, can include, for example, programmable circuitry programmed with specific software and/or firmware, special-purpose hardwired circuitry, or a combination thereof.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

What is claimed is:

1. A method comprising:
providing a computer software application to a plurality of users;
receiving user activity data of at least some of the plurality of users including a first user, each user being active within an instance of the application running on a computer system;
randomly selecting the first user;
sending a survey regarding the application to the first user;
collecting a survey answer from the first user;
recording the survey answer and the user activity data in a database stored in a server; and
generating, by the server, an application quality score for the application depending on the survey answer and the user activity data, wherein the application quality score suggests a quality level of the application.

2. The method of claim 1, further comprising:
sending a recommendation of the application to a user device based on the application quality score.

3. The method of claim 1, wherein the step of receiving includes:
determining a number of days among last N days on which the first user was active within an instance of the application, wherein N is a predetermined number.

4. The method of claim 1, wherein the step of sending comprises:
sending a survey regarding the application to the first user, the survey inviting the first user to provide a quality rating for the application.

5. The method of claim 1, wherein the survey answer is a rating scale number.

6. The method of claim 1, wherein the step of generating includes:
generating an application quality score for the application depending on a plurality of survey answers and a plurality of user activity data from a plurality of users of the application, wherein the user activity data are based on activities of the users who are active within the instances of the application.

7. The method of claim 6, wherein the users have a common demographic or geographic attribute.

8. The method of claim 6, wherein the user activity data depend on a number of days among last N days on which each user of the users was engaging an instance of the application, N being a predetermined number.

9. The method of claim 1, wherein the step of generating comprises:
calculating a user quality score for the first user determined by a square of the survey answer plus a common logarithm of a daily active usage value of the user, wherein the survey answer is a scale rating number and the daily active usage value of the user is a number of days among last N days on which the user was active within an instance of the application, N being a predetermined number; and
generating an application quality score for the application by averaging the user quality score for the first user and other user quality scores for other users.

10. The method of claim 1, further comprising:
sending an application chart to a user device, the application chart listing a plurality of applications by an order of the application quality scores of the applications.

11. The method of claim 1, further comprising:
calculating a taste similarity score between the application and a second application within which a second user has been active; and
sending a recommendation of the application to the second user if the quality score of application exceeds a threshold value and the taste similarity score exceeds a second threshold value.

12. The method of claim 1, further comprising:
calculating a taste similarity score between the first user and a second user, wherein the taste similarity score depends on social network information of the first user and the second user; and
sending a recommendation of the application to the second user if the quality score of application exceeds a threshold value and the taste similarity score exceeds a second threshold value.

13. The method of claim 1, wherein the application is designed to run on a computer, a mobile device, a web page, or a Canvas page.

14. A method comprising:
recording activity data of users who are actively engaging instances of an application in a database stored in a server;
transmitting rating requests for the application to a plurality of users, wherein the plurality of users are randomly selected from the users who are actively engaging the instances of an application;
receiving and entering rating answers from the plurality of users into the database, wherein each of the rating answers is a scale rating number;
calculating an application quality score for the application based on the rating answers and the activity data; and
transmitting a computer message of recommending the application based on the application quality score to a user device that has not installed the application.

15. The method of claim 14, wherein the activity data for each individual user who is actively engaging an instance of the application includes a number of days among last N days on which that individual user was engaging the instance of the application, N being a predetermined number.

16. The method of claim 14, wherein the step of calculating comprises:
calculating a user quality score for each individual user determined by a square of the rating answer from that individual user plus a common logarithm of the activity data of that individual user, and
generating an application quality score for the application by averaging the user quality scores for the plurality of users.

17. The method of claim 14, further comprising:
calculating a taste similarity score based on social networking data of a user who has not engaged the application;
and wherein the step of sending comprises:
sending a recommendation of the application to the user who has not engaged the application if the application quality score exceeds a first threshold value and the taste similarity score exceeds a second threshold value.

18. A social networking system comprising:
a survey module configured to transmit rating requests for an application to a plurality of users, wherein the plurality of users are randomly selected from users who are active within instances of the application;
a database configured to record activity data of the users who are actively using the application and rating answers from the plurality of users, wherein each of the rating answers is a scale rating number;
an application assessing module configured to calculate an application quality score for the application based on the rating answers and the activity data; and
a recommendation module configured to generate and send a recommendation of the application to a user who has not active within an instance of the application.

19. The social networking system of claim 18, wherein the recommendation of the application is generated based on the application quality score and a taste similarity score, the taste similarity score depends on social networking information of the user who has not active within an instance of the application and the users who are active within the instances of the application.

20. The social networking system of claim 18, wherein the application quality score is updated in real time based on real-time activity data of the users who are active within the instances of the application and real-time incoming rating answers.
